(19) United States
(12) Patent Application Publication
(10) Pub. No.: US 2001/0052201 A1
(43) Pub. Date: Dec. 20, 2001

(54) Door opening and closing device

(76) Inventors: Woon-Young Choi, Incheon (KR); Il-Hee Lee, Incheon (KR)

Correspondence Address: NIXON PEABODY, LLP, 8180 GREENSBORO DRIVE, SUITE 800, MCLEAN, VA, 22102, US

(21) Appl. No.: 09/877,043

(22) Filed: Jun. 11, 2001

(30) Foreign Application Priority Data
Jun. 20, 2000 (KR) 2000-17491

(51) Int. Cl. E05F 15/00

(52) U.S. Cl. 49/139

(57) ABSTRACT

A door opening and closing device adapted for use at reinforce glass door or front door for gentle and quick swivel when a door is opened and for slow rotation when the door is closed, wherein the device comprises: a shaft rotatably supporting a door and coupled to the door for integral rotation with the door; a piston inserted to a circumference of the shaft so as to vertically move along a lengthwise direction of the shaft; a connector for connecting the shaft with the piston for the piston to move vertically in response to rotary movement of the shaft; a housing for receiving therein the shaft and the piston and having an upper chamber and a lower chamber partitioned by the piston, each chamber filled with operation fluid; a first fluid passage formed at an inner wall surface of the housing for communicating the upper chamber with the lower chamber; and a check valve mounted at the piston for being opened when the piston is upwardly moved to allow the operation fluid in the upper chamber to move to the lower chamber and for being closed when the piston is downwardly moved to allow the operation fluid in each chamber not to communicate therebetween.

### BACKGROUND OF THE INVENTION

1. Field of the Invention

The present invention relates to a door opening and closing device, and more particularly to a door opening and closing device adapted for use at reinforce glass door or front door for gentle and quick swivel when a door is opened and for slow rotation when the door is closed.

2. Description of the Prior Art

Various doors such as reinforced glass door, front door at an apartment, exit door for an office and the like are installed with door opening and closing devices where the door opened at a less than predetermined angle is made to be closed automatically. The door opening and closing devices are developed in various types and a variety of names such as floor hinge, door closer and the like are known according to types of door used.

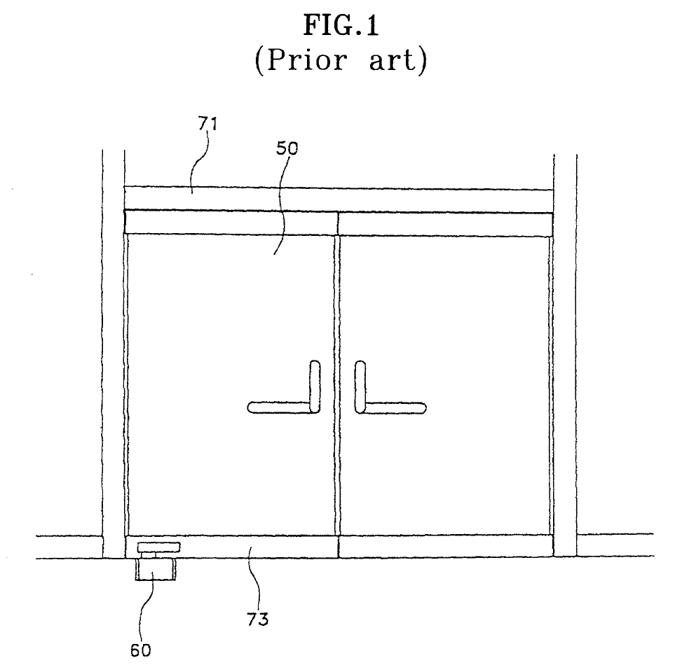

FIG. 1 is a plan view for illustrating a reinforced glass door where a door opening and closing device is installed according to the prior art.

The reinforced glass door 50 is hinged at an upper end and a lower end thereof to each end of an upper frame 71 and a lower frame 73 equipped at a circumferential area of a building exit, to be rotated clockwise or counterclockwise for opening and closing. A lower hinge of the reinforced glass door 50 is mounted with a door opening/closing device 60 for automatically closing the door and buried for installation underneath a building floor.

However, there is a problem in the door opening and closing device 60 according to the prior art thus described in that the door 60 becomes less operative after a long time of use such that when the reinforced glass door 50 is let to be released after it is opened, the reinforced glass door 50 is closed relatively very fast by resilient restoring force thereof, prompting an ensuing person to get hit thereto or a hand to get caught to the dangerous safety hazard of users.

### SUMMARY OF THE INVENTION

The present invention is disclosed to solve the aforementioned problems and it is an object of the present invention to provide a door opening and closing device adapted to be softly but quickly opened when a door is opened and to be slowly closed when the door is closed, allowing a user to enter and exit safely and easily through the door. It is another object of the present invention to provide a door opening and closing device adapted to be downsized in overall size thereof to a compact size, allowing an easy installation. It is still another object of the present invention to provide a door opening and closing device adapted to be appropriately adjusted in opening and closing speed of the door.

In accordance with the objects of the present invention, there is provided a door opening and closing device, the device comprising:

a shaft rotatably supporting a door and coupled to the door for integral rotation with the door;

a piston inserted to a circumference of the shaft so as to vertically move along a lengthwise direction of the shaft;

connecting means for connecting the shaft with the piston for the piston to move vertically in response to rotary movement of the shaft;

a housing for receiving therein the shaft and the piston and having an upper chamber and a lower chamber partitioned by the piston, each chamber filled with operation fluid;

a first fluid passage formed at an inner wall surface of the housing for communicating the upper chamber with the lower chamber; and

a check valve mounted at the piston for being opened when the piston is upwardly moved to allow the operation fluid in the upper chamber to move to the lower chamber and for being closed when the piston is downwardly moved to allow the operation fluid in each chamber not to communicate therebetween.

According to a preferred embodiment of the present invention, the door opening and closing device further comprises a spring between the piston and the housing for promoting the vertical movement of the piston wherein the connecting means further includes an operation groove slantly formed either at external circumferential surface of the shaft or internal circumferential surface of the piston in symmetrical position and an operation pin mounted either at the piston or the shaft for being inserted at one end thereof into the operation groove to be movably guided along the operation groove, whereas a fixed groove is formed at an end portion of the upwardly formed operation groove for an end of the operation pin to be hitched thereat.

Furthermore, the piston is vertically and lengthwise formed at a circumferential surface thereof with a key groove for guiding vertical movement of the piston and a key is mounted at an inner wall surface of the housing so that one part thereof can be inserted thereinto. A flow rate control valve is disposed at the first fluid passage for controlling opening and closing degree of the first fluid passage.

### BRIEF DESCRIPTION OF THE INVENTION

For fuller understanding of the nature and objects of the invention, reference should be made to the following detailed description taken in conjunction with the accompanying drawings in which:

FIG. 1 is a plan view for illustrating a reinforced glass door where a door opening/closing device is installed according to the prior art;

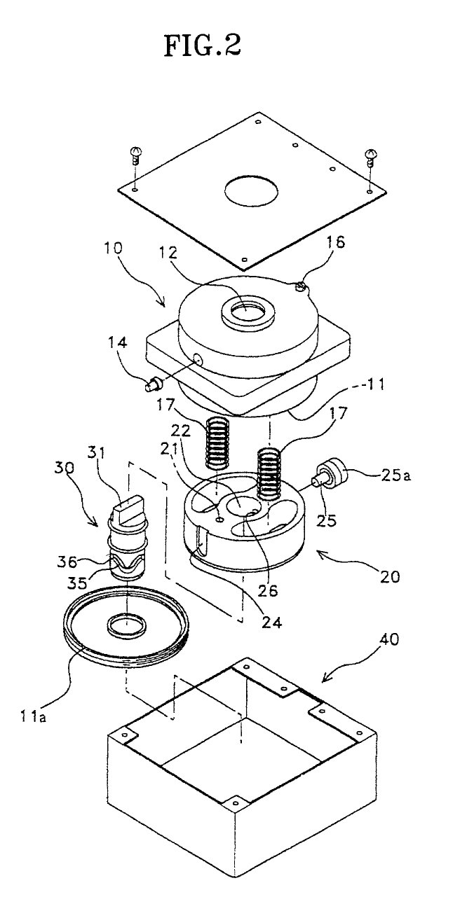

FIG. 2 is an exploded perspective view of a door opening and closing device according to the present invention;

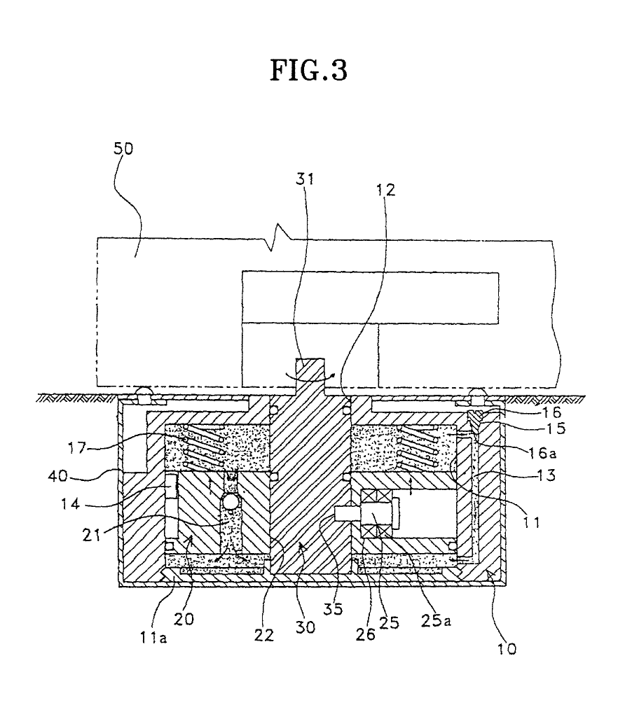

FIG. 3 is a sectional view for illustrating an operation state when a door is opened by a door opening and closing device according to the preset invention; and

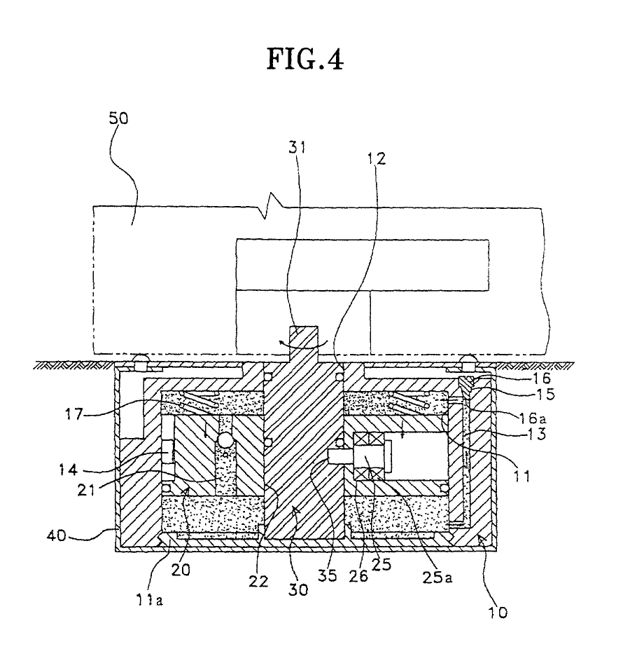

FIG. 4 is a sectional view for illustrating an operating state when a door is closed by a door opening and closing device according to the present invention.

### DETAILED DESCRIPTION OF THE INVENTION

Now, preferred embodiment of the present invention will be described in detail with reference to the accompanying drawings.

FIG. 2 is an exploded perspective view of a door opening and closing device according to the preset invention and FIG. 3 is a sectional view for illustrating an operation state when a door is opened by a door opening and closing device according to the present invention.

In the drawings, a shaft 30 is attached to a door 50 for rotatably supporting the door 50. In other words, a protruding end 31 of the shaft 30 is fixedly coupled to a lower end of the door 50 such that, when the door 50, being supported to the shaft 30, receives an external manipulating force for rotation, the shaft 30 is integrally rotated with the door 50.

Furthermore, resistance providing means is mounted for providing resistance to the shaft 30 in order to control rotary motion speed of the door 50 by blocking rotary motion of the shaft 30 when the shaft 30 is rotated by rotation of the door 50, where the resistance providing means provides to the shaft 30 resistance power, each different in magnitude thereof in response to rotary motion directions of the shaft 30.

In other words, the resistance providing means provides a relative small resistant power to the shaft 30 when the door 50 is opened, allowing the door 50 to be smoothly opened by a small force, whereas the shaft 30 is provided with a relatively large resistant power when the door is closed, thereby allowing the door to be slowly closed.

At this location, the resistance providing means includes a piston 20 inserted to a circumference of the shaft 30 so as to be vertically moved along a lengthwise direction of the shaft 30, connecting means for connecting the shaft 30 with the piston 20 to allow the piston to be vertically moved in response to rotary motion of the shaft 30 and hydraulic resistance providing means for providing to the piston 20 a hydraulic resistance power for blocking piston movement when the piston 20 is moved, each in different magnitude for upward movement and downward movement of the piston 20.

In other words, when the shaft 30 is rotated by rotary movement of the door 50, the rotaty movement of the shaft 30 is transmitted to the piston 20 by the connecting means, prompting the piston 20 to rise or fall in response to rotary direction of the shaft 30, where the piston 20 is raised when the door 50 is opened while the piston 20 is lowered when the door 50 is closed.

At this time, the connecting means includes an operation groove 35 slantly formed in symmetrical shape on an external circumferential surface and an operation pin 25 mounted at the piston 20 for being inserted at one end thereof into the operation groove 35 to be movably guided along the operation groove 35.

The operation groove 35 is formed at an upward end portion thereof with a fixed groove for an end of the operation pin 25 to be hitched thereat. The piston 20 is radially formed with a coupling hole 26 of a predetermined depth from an external peripheral surface to an internal peripheral surface such that the operation pin 25 is inserted into the coupling hole 26 to be rotatably supported via a bearing. The operation pin 25 is protruded at one end thereof through an internal peripheral surface of the piston 20 to be inserted into the operation groove 35.

Furthermore, the operation pin 25 and the operation groove 35 are so assembled as to allow an end of the operation pin 25 to be positioned at a lowermost area of the operation groove 35 when the door 50 is on a closed position.

As a result, when the door 50 is in a closed state, in other words, when the door 50 receives an external force to thereby be rotated to one direction while the operation pin 25 is positioned at the lower most area of the operation groove 35, the operation pin 25 is raised along the operation grove 35 and at the same time the piston 20 integrally coupled with the operation pin 25 is also raised along with the operation pin 25.

Meanwhile, when the door 50 is reversely rotated, the operation pin 25 is lowered along wit the operation groove 35 and concurrently the piston 20 is also descended. As mentioned above, the rotary movement of the shaft 30 is transmitted to the piston 20 by the connecting means to prompt the piston 20 to perform the vertical movement in concert with the rotary movement of the shaft 30.

Although the present embodiment has described about the operation pin 25 mounted to the piston 20 and the operation groove 35 formed at the shaft 30, the present invention is not to be limited thereto but should be apparent that same effect can be obtained with the operation groove formed at the piston 20 and the shaft 30 installed with the operation pin 25.

Furthermore, a key groove 24 is vertically and lengthwise formed at a peripheral surface of the piston 20 for guiding the vertical movement of the piston 20, and a key 14, one part of which being inserted into the key groove 24, is protrudingly mounted at an inner wall surface of the housing. As a result, the piston 20 cannot be rotated due to reciprocal operation between the key 14 and the key groove 24 but is only restricted to move vertically.

Meanwhile, the hydraulic resistance providing means includes a housing 10 for respectively accommodating the shaft 30 and the piston 20 therein. The housing 10, being a cylindrical member, is formed thereon with a shaft hole 12 for an end 31 of the shaft 30 to be protrusively inserted while the housing 10 is open thereunder. The housing 10 is coupled thereunder to a floor plate 11a so as to be tightly closed thereby, while the floor plate 11a receives the other end of the shaft 30 to be rotatably supported.

Furthermore, a chamber 11 is airtightly formed by an inner wall of the housing 10 and the floor plate 11a. The piston 20, being inserted into the chamber 11, partitions the chamber 11 into an upper chamber and a lower chamber where the chamber 11 is filled up with operation fluid.

The hydraulic resistance providing means is equipped with operation fluid communicating means for letting the operation fluid in each chamber communicate therebetween when the piston 20 moves vertically, where the operation fluid communicating means includes a first fluid passage vertically formed at an inner wall surface of the housing 10 with a predetermined diameter for communicating the upper chamber and the lower chamber and a check valve 21 formed at the piston 20 with a larger diameter than that of the first fluid passage 13 and for being opened when the piston is moved upward and for being closed when the piston is moved downward.

In other words, when the piston 20 is raised by rotary movement of the shaft 30 as illustrated in FIG. 3 while the door 50 is opened, the operation fluid filled in the upper chamber is introduced into the lower chamber via the first fluid passage 13 and the check valve 21.

When the operation fluid in the upper chamber flows into the lower chamber through the first fluid passage 13 and the check valve 21, a hydraulic resistance the piston receives when the piston is upwardly moved becomes relatively smaller than that of the piston which is moved downwardly, such that the door 50 can be smoothly opened with a reduced small power.

Meanwhile, when the door 50 is continuously pushed or pulled toward the opening direction thereof, the operation pin 25 is raised along the operation groove 35 but later is hitched by the operation groove 36 formed at the end portion of the operation groove 35 and becomes unmovable thereat, where, even an external force is applied thereto, the door is no longer rotated whereby the piston is no longer raised.

Under this circumstance, even when the external force being applied to the door 50 is removed, the door 50 maintains the opened state because the operation pin 25 is being hitched by the fixed groove 36.

Furthermore, when an external force is applied in the opposite direction to the door 50 which keeps an opened state by the mutual operation pin 25 and the fixed groove 36, thereby forcing the operation pin 25 to be detached from the fixed groove 36 or when the door 50 is opened to as much as a predetermined angle and is applied with an external force to a door-closing direction, the operation pin 25 is lowered along the operation groove 35 and simultaneously the piston 20 is also descended. A restoring spring 17 is disposed between an inner wall surface of the housing 10 and an upper surface of the piston in the upper chamber to promote the descending movement of the piston 20.

The operation fluid in the lower chamber is introduced into the upper chamber only through the first fluid passage 13 when the piston 20 is lowered by the closing movement of the door 50 as shown in FIG. 4. In other words, the fluid in the lower chamber is moved to the upper chamber only through the first fluid passage 13 because the check valve 21 is blocked by ball thereof. As a result, fluid amount of operation fluid between the two chambers is smaller when the piston 20 is lowered than when the piston 20 is upwardly moved, whereby fluid resistance applied to the piston 20 and the shaft 30 is increased as much as the reduced fluid amount, thereby allowing the door 50 to be slowly closed.

Meanwhile, the first fluid passage 13 is mounted with a flow rate control valve 16 for controlling opening and closing degree of the first fluid passage 13.

In other words, the housing 10 is formed thereon with a valve mounting hole 15 communicating with the first fluid passage 13 while the valve mounting hole 15 is installed with a flow rate control valve 16 having a protruder 16a which can be protruded into the first fluid passage 13.

When the protruder 16a controls a protruded size that is protruded into the first fluid passage 13, fluid amount of the operation fluid flowing through the first fluid passage 13 is controlled and, at the same time, the piston 20 is also controlled in descending speed thereof such that closing speed of the door 50 can be properly and randomly controlled.

Meanwhile, it is preferable to bury the housing 10 underneath the floor of entrance, encased in a predetermined size of a case 40.

When the vertical lengths of the shaft 30 and the piston 20 are shortened as much as possible, it becomes easier for the door opening and closing device to be installed.

As apparent from the foregoing, there is an advantage in the door opening and closing device thus described according to the present invention in that a door can be smoothly and swiftly opened when the door is opened while the door can be slowly shut when the door is closed, such that a user can enter or leave the door safely and comfortably. There is another advantage in that the overall dimension may be reduced to a compact size, thereby allowing an easy installation. There is still another advantage in that opening and closing speed of a door can be appropriately controlled in answer to a need.

What is claimed is:

1. A door opening and closing device, the device comprising:
a shaft rotatably supporting a door and coupled to the door for integral rotation with the door;
a piston inserted to a circumference of the shaft so as to vertically move along a lengthwise direction of the shaft;
connecting means for connecting the shaft with the piston for the piston to move vertically in response to rotary movement of the shaft;
a housing for receiving therein the shaft and the piston and having an upper chamber and a lower chamber partitioned by the piston, each chamber filled with operation fluid;
a first fluid passage formed at an inner wall surface of the housing for communicating the upper chamber with the lower chamber; and
a check valve mounted at the piston for being opened when the piston is upwardly moved to allow the operation fluid in the upper chamber to move to the lower chamber and for being closed when the piston is downwardly moved to allow the operation fluid in each chamber not to communicate therebetween.

2. The device as defined in claim 1, wherein an one end of the shaft penetrates the housing and protrudes therethrough to be coupled to the door.

3. The device as defined in claim 2, wherein the housing is releasably coupled to a floor plate while the floor plate is supported by the other end of the shaft.

4. The device as defined in claim 1, wherein a spring is disposed between the piston and the housing for promoting the piston to move downward.

5. The device as defined in claim 1, wherein the connecting means further comprises:
an operation groove slantly formed either at external circumferential surface of the shaft or internal circumferential surface of the piston in symmetrical position; and
an operation pin mounted either at the piston or the shaft for being inserted at one end thereof into the operation groove, whereas a fixed groove is formed at an end portion of the upwardly formed operation groove for an end of the operation pin to be hitched thereat.

6. The device as defined in claim 5, wherein the operation pin is rotatably supported via a bearing.

7. The device as defined in claim 1, wherein the piston is vertically and lengthwise formed at a circumferential surface thereof with a key groove for guiding vertical movement of the piston and a key is mounted at an inner wall surface of the housing so that one part thereof can be inserted thereinto.

8. The device as defined in claim 1, wherein a flow rate control valve is disposed at the first fluid passage for controlling opening and closing degree of the first fluid passage.

9. The device as defined in claim 1, wherein the housing is accommodated in a case and mounted on a floor.

10. The device as defined in claim 1, wherein respective lengths of the housing and the case are larger than respective heights thereof.
